(19) United States
(12) Patent Application Publication
(10) Pub. No.: US 2017/0039999 A1
(43) Pub. Date: Feb. 9, 2017

(54) Photon latency measurement system and method

(71) Applicant: Basemark Oy, Helsinki (FI)

(72) Inventors: Arto Ruotsalainen, Järvenpää (FI); Mikko Alaluusua, Helsinki (FI); Alexandre Cardoso, Espoo (FI)

(21) Appl. No.: 15/229,153

(22) Filed: Aug. 5, 2016

Related U.S. Application Data
(60) Provisional application No. 62/201,128, filed on Aug. 5, 2015.

(51) Int. Cl. G09G 5/12; G09G 5/00; H04L 12/26

(52) U.S. Cl. CPC G09G 5/12; H04L 43/0858; G09G 5/006; G09G 2320/0252

(57) ABSTRACT

In accordance with an example embodiment, there is provided a benchmarking method for measuring latency from a computer application to a physical display, said method including measuring a time interval between the application's call to present new information and when said new information appears on the physical display. Optionally, the benchmarking method may further comprise detecting changes on the physical display with an exact display refresh rate.

### BACKGROUND

Latency measurement of application to photon (physical display) is not a trivial task as it requires understanding the whole pipeline from application to display and external device(s) which are accurate enough to detect changes up to 240 times in second or even more. After the measurement pipeline is ready, it requires very careful syncing between the external device(s) and measuring framework to match the timestamps in order to get valid results.

Measuring of latency between application and display is becoming more and more important as games, virtual reality, user interfaces, videos require more accurate displaying of information faster and on correct time. Particularly, in virtual reality the latency is essential for having a great user experience. If the latency is too high, users get nauseous / motion sickness, thus not being able to use the products.

### SUMMARY

In accordance with a first aspect of the present invention, there is provided a benchmarking method for measuring latency from a computer application to a physical display, said method including the steps of measuring a time interval between the application's call to present new information and when said new information appears on the physical display.

In accordance with a second aspect of the present invention, there is provided a non-transitory computer readable medium having stored thereon a set of computer readable instructions that, when executed by at least one processor, cause an apparatus to at least perform a method for measuring latency from a computer application to a physical display, said method including the steps of measuring a time interval between the application's call to present new information and when said new information appears on the physical display.

### BRIEF DESCRIPTION OF THE FIGURES

FIG. 1 illustrates an example system in accordance with at least some embodiments of the present invention.

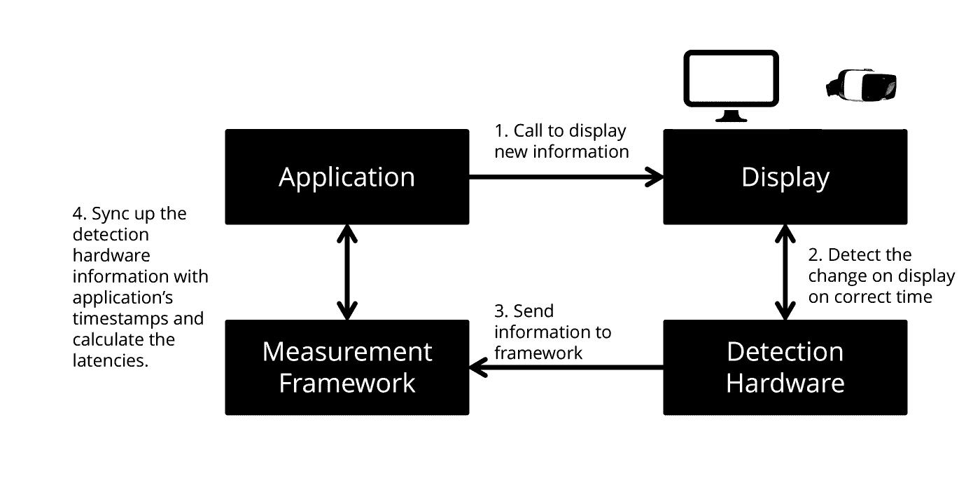

### DETAILED DESCRIPTION

Elements of embodiments of the invention:
Measurement of the time between an application's call to present new information and when it actually appears on a display
Detection of display changes with exact display refresh rate (Hz) using external IP hardware
Syncing information between software and hardware to match correct timing

The Display may comprise, for example, a Monitor, Head-Mounted Display, or other screen.

A Measurement Framework can be, for instance, Basemark's IP software module for benchmarking.

Detection Hardware can be, for instance, Basemark's IP hardware for detecting and capturing changes on the screen. The hardware may comprise a camera, for example. Such a camera may be directed to image the Display.

Latency measurement process can start when an application and a Measurement Framework are executed. After initialization the application logic loop can start, this can comprise, but is not necessarily limited to, handling of input, setting up correct user interface components and reading data to update the application to be presented on a Display.

The Measurement Framework may comprise software arranged to run on a same computing hardware as the Application, or, alternatively, the Detection Hardware. A communication interface enables synchronization between the Application and the Measurement Framework, for example by transmission of signals. Such signals may comprise timestamp information, for example. Where Measurement Framework is run on the same computing hardware as the Application, timestamps internal to this computing hardware may be employed, for example.

At the end of an application logic loop, the application can ask the display drivers to present new information on the Display. This can occur by two potential example use cases: in case of a single latency measurement the application can start waiting for the notification from a Measurement Framework of a Detection Hardware to detect the change on the Display. In case of continuous latency testing the application may, optionally, not wait for the response from Measurement Framework, instead continuing the application logic loop and the Measurement Framework can map the measurement instances correctly to corresponding present requests.

After this and/or simultaneously, the application can inform the Measurement Framework of a new latency measurement instance. This can inform the Detection Hardware to start measuring. Once Detection Hardware notices the change, it can send a notification and, for example, some additional data, to the Measurement Framework. The Measurement Framework can then match it with the correct latency measurement instance in order to calculate the latency result.

For example, Measurement Framework may compare a first timestamp generated by or responsive to the Application in connection with instructing Display to perform the presenting of the new information, with a second timestamp generated in connection with Detection Hardware noticing the change on the Display. A time elapsed between the first and second timestamp corresponds to a delay in updating the Display. This completes the measurement of the display system. In some embodiments, Measurement Framework is further configured to subtract from the time elapsed between the first and second timestamp a delay specific to the Detection Hardware. Such a Detection Hardware specific delay may be determined beforehand, for example.

In some embodiments, the second timestamp is triggered by a hardware driven interrupt, caused in the computing hardware that runs Measurement Framework. The hardware driven interrupt may be triggered by an electrical signal from Detection Hardware, for example. A hardware driven interrupt may provide the benefit that software related delays in the hardware that runs Measurement Framework do not fluctuate, since the interrupt directly causes processing to divert to the generation of the second timestamp.

Alternatively or additionally to a second timestamp, the first timestamp may be compared, in general, to timing information obtained, in Measurement Framework, as a response to the Detection Hardware. The second timestamp is an example of timing information.

Alternatively or additionally to a first timestamp, more general timing information may be used. The first timestamp is an example of timing information. Overall, first timing information generated in connection with instructing Display to perform the presenting of the new information may be compared to second timing information generated in connection with, or responsive to, Detection Hardware noticing the change on the Display. A first timestamp is an example of the first timing information and a second timestamp is an example of second timing information.

The first timestamp may be internal to an apparatus, that is, a computing hardware, that runs the Application. Therefore, where the computing hardware also runs the Measurement Framework, the latency measurement method may be performed in this computing hardware.

A computing hardware may comprise, for example, a processor comprising at least one processing core, such as a Bulldozer core by AMD corporation or a Cortex core by ARM Corporation. The computing hardware may also comprise memory, such as DRAM or other RAM memory configured to store a computer readable instructions and data, such as timestamps, for example. Computing hardware may further comprise, for example, a hardware based clock signal generator the computing hardware may use in generating reliable timestamps.

The system can be used to help create a definitive PC system test for, for instance, virtual reality (VR) gaming. A new VR benchmark can enable gamers and PC hardware companies to easily assess the level of experience they can expect when running virtual reality content. Additionally it can be the first service available that gives users recognizable, real-world metrics to describe their system's VR readiness with various HMDs out there.

The benchmark method and/or system can provide detailed feedback in areas such as the best graphical settings to use with a variety of VR headsets. Using measuring performance standards for example, an objective test that evaluates everything from frame rate capabilities to memory consumption, latency issues, 3D audio performance and much more can be created.

Clauses relating to the disclosure:

a) A benchmarking method for measuring latency from a computer application to a physical display, said method including the steps of:
measuring a time interval between the application's call to present new information and when said new information appears on the physical display.

b) The benchmarking method of clause a, further comprising detecting changes on the physical display with an exact display refresh rate.

c) The benchmarking method of clause b, wherein external IP hardware is used for the detecting step.

d) The benchmarking method of any of the preceding clauses, further comprising syncing the new information between the application and hardware based on the measured time interval.

e) The benchmarking method of clause d, wherein the hardware includes a virtual reality display component.

f) The benchmarking method of any of the preceding clauses, further comprising using a measurement framework which receives information from at least detection hardware for detecting when said new information appears on the physical display.

g) The benchmarking method of clause f, wherein the measurement framework receives time stamped data from the application regarding the call to present the new information.

h) The benchmarking method of any of the preceding clauses, wherein the measurement framework carries out at least said measuring step.

i) The benchmarking method of any of the preceding clauses, wherein the measurement framework carries out at least said syncing step.

j) The benchmarking method of any of the preceding clauses, further comprising using physical detection hardware, e.g. a camera, light detecting source or other signal detecting source for determining when said new information appears on the physical display.

k) The benchmarking method of clause j, wherein the physical detection hardware is a part of the physical display.

l) The benchmarking method of clause j or k, wherein the physical detection hardware is physically separate from the physical display.

m) The benchmarking method of clause j, k or 1, wherein the physical detection hardware is electrically separate from the physical display.

n) The benchmarking method of any of the preceding clauses, further comprising using physical detection hardware which automatically detects the presentation of the new information on the physical display and sends time stamped and/or time containing data to a measurement framework.

o) A benchmarking system for carrying out the method of any of the preceding clauses.

p) A non-transitory computer readable medium for carrying out any of the clauses a through n.

q) A benchmarking system comprising a non-transitory computer readable medium having a measurement framework for receiving time data from an application and detection hardware and capable of measuring a time interval between the application's call to present new information and when said new information appears on the physical display.

r) The benchmarking system of clause q, further comprising the physical display, the application, detection hardware or a combination thereof.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A benchmarking method for measuring latency from a computer application to a physical display, said method including:
measuring a time interval between the application's call to present new information and when said new information appears on the physical display.

2. The benchmarking method of claim 1, further comprising detecting changes on the physical display with an exact display refresh rate.

3. The benchmarking method of claim 2, wherein external IP hardware is used for the detecting step.

4. The benchmarking method of claim 1, further comprising syncing the new information between the application and hardware based on the measured time interval.

5. The benchmarking method of claim 4, wherein the hardware includes a virtual reality display component.

6. The benchmarking method of claim 1, further comprising using a measurement framework which receives information from at least detection hardware for detecting when said new information appears on the physical display.

7. The benchmarking method of claim 6, wherein the measurement framework receives time stamped data from the application regarding the call to present the new information.

8. The benchmarking method of claim 1, wherein the measurement framework carries out at least said measuring step.

9. The benchmarking method of claim 1, wherein the measurement framework carries out at least said syncing step.

10. The benchmarking method of claim 1, further comprising using physical detection hardware, for determining when said new information appears on the physical display.

11. The benchmarking method of claim 10, wherein the physical detection hardware is a part of the physical display.

12. The benchmarking method of claim 10, wherein the physical detection hardware is physically separate from the physical display.

13. The benchmarking method of claim 10, wherein the physical detection hardware is electrically separate from the physical display.

14. The benchmarking method of claim 1, further comprising using physical detection hardware which automatically detects the presentation of the new information on the physical display and sends timestamped and/or time containing data to a measurement framework.

15. A benchmarking system comprising a non-transitory computer readable medium having a measurement framework for receiving time data from an application and detection hardware and capable of measuring a time interval between the application's call to present new information and when said new information appears on the physical display.

16. The benchmarking system of claim 17, further comprising the physical display, the application, detection hardware or a combination thereof.

17. A non-transitory computer readable medium having stored thereon a set of computer readable instructions that, when executed by at least one processor, cause an apparatus to at least perform a method for measuring latency from a computer application to a physical display, said method including measuring a time interval between the application's call to present new information and when said new information appears on the physical display.
